(19) United States
(12) Patent Application Publication
(10) Pub. No.: US 2010/0187053 A1
(43) Pub. Date: Jul. 29, 2010

(54) DISK BRAKE

(75) Inventors: Siegfried Botsch, Grafenau (DE); Klaus Jaeckel, Nersingen (DE); Martin Lesch, Waiblingen (DE); Christian Quinger, Schorndorf (DE); David Wilke, Allmersbach im Tal (DE)

Correspondence Address: PATENT CENTRAL LLC;Stephan A. Pendorf, 1401 Hollywood Boulevard, Hollywood, FL, 33020, US

(73) Assignee: DAIMLER AG, Stuttgart (DE)

(21) Appl. No.: 12/664,912

(22) PCT Filed: Jul. 18, 2008
(86) PCT No.: PCT/EP2008/005889

§ 371 Date: Dec. 16, 2009

(30) Foreign Application Priority Data
Jul. 31, 2007 (DE) 10 2007 035 829.8

(51) Int. Cl. F16D 65/12; B23P 11/00

(52) U.S. Cl. 188/218 XL; 29/525.01

(57) ABSTRACT

The invention relates to a disk brake, especially for a motor vehicle, comprising a wheel hub (10) and a friction ring (18), which are firmly interconnected radially by a form lock (24) and axially by at least one securing element (26). The invention is characterized in that the at least one axial securing element (26) is arranged in a receiving recess (38) which extends radially inside the friction ring (18), said friction ring (18) being radially movable relative to the securing element (26) in the area of the receiving recess (38).

The invention relates to a disk brake, especially for a motor vehicle, of the type indicated in the preamble of claim 1. The invention further relates to a method for the assembly of such a disk brake, especially for a motor vehicle, of the type indicated in the preamble of claim 10.

Such a disk brake is for example already known from DE 199 18 069 B4 or from DE 198 39 763 B4 The respective disk brake is thereby formed in two parts and comprises a friction ring in addition to a wheel hub, which ring is connected in a fixed manner to the wheel hub, radially by a positive fit connection—especially a spline shaft connection—, and axially by a plurality of securing elements. The securing elements are thereby essentially formed by intermediate elements, which project between knobs or teeth on the wheel hub side and support elements on the friction ring side, which form the positive fit connection, extending in the circumferential direction and thereby ensure amongst others the axial fixing of the friction ring at the wheel hub.

It is problematic with these brake disks that, for example with a brake disk connected on one side—due to irregular temperature distribution—a warping of the friction ring or of the brake disk altogether can occur. Fundamental tensions result from this warping and irregular temperature distribution, which can lead to fractures, so-called heat fractures at the surface of the friction ring.

It is thus the object of the present invention to create a brake disk and a method for the assembly of such a brake disk, where a simple and fast assembly of the friction ring at the wheel hub or the brake pot is possible on the one hand, and with which the danger of a fracture formation is reduced considerably on the other hand.

This object is solved according to the invention by a disk brake and a method for the assembly of such a brake disk and a disk brake with the characteristics of claim 1 or 10. Advantageous arrangements with practical and non-trivial further developments of the invention are given in the depending claims.

So as to create a disk brake with a brake disk, especially for a motor vehicle, which enables a simple assembly of the friction ring at the wheel hub on the one hand, and with which the danger of fracture formations is considerably reduced on the other hand, it is provided according to the invention that the at least one axial securing element is arranged in a receiving recess which extends radially inside the friction ring, wherein the friction ring is radially movable relative to the securing element in the area of the receiving recess. In other words, it is provided according to the invention to provide at least one axial securing element, which extends radially within the friction ring, so that a simple fixing of the friction ring in the axial direction of the wheel hub is created hereby.

However, so as to avoid a warping of the brake disk or the friction ring due to an uneven temperature distribution, it is radially movable in the region of the receiving recess relative to the securing element. By this radial mobility, the friction ring can thus extend freely in the radial direction with a corresponding temperature distribution, without corresponding forces being introduced into the friction ring by the securing element, which could lead to a warping or deformation—and, accompanying this—a fracture formation. By the reduction of the brake disk warping and the heat tensions, the brake disk or the friction ring thus do not tend to have a fast fracture formation, whereby altogether larger service lives of the brake disk and the brake pads or of the friction ring can be achieved.

In a further design of the invention, it has further been shown to be advantageous if the securing element comprises a sleeve fastened to the wheel hub by means of a screw, which surrounds the screw on the outer circumferential side. The desired free mobility of the friction ring in the radial direction relative to the securing element can thereby be achieved.

It has also been shown to be advantageous in a further design of the invention if the receiving recess is formed as a passage opening, which penetrates the friction ring from an outer circumferential side to the wheel hub. A simple fixing of the securing element is thereby possible. It has been shown to be particularly advantageous in a further design of the invention if the screw is screwed in from the outer circumferential side of the friction ring, wherein a screw head is dimensioned smaller in its cross section than the receiving recess. By this design, the securing element or the sleeve can thereby be fixed from the outer circumferential side by means of the screw, whereby a particularly simple assembly can be realized. As the screw head is thereby dimensioned smaller in its cross section than the receiving recess, it is ensured that the friction ring can move in the radial direction relative to the securing element.

It has finally been shown to be advantageous if a plurality of securing elements is provided, which are preferably arranged with the same mutual angles. By this, a warping of the friction ring or of the brake disk is avoided in a particularly good manner, and the danger of fracture formation accompanying this is avoided.

The advantages listed above in connection with the disk brake according to the invention are valid in the same manner for the method for the assembly of such a disk brake according to claim 7.

Further advantages, characteristics and details of the invention result from the following descriptions of individual embodiments and by means of the drawings.

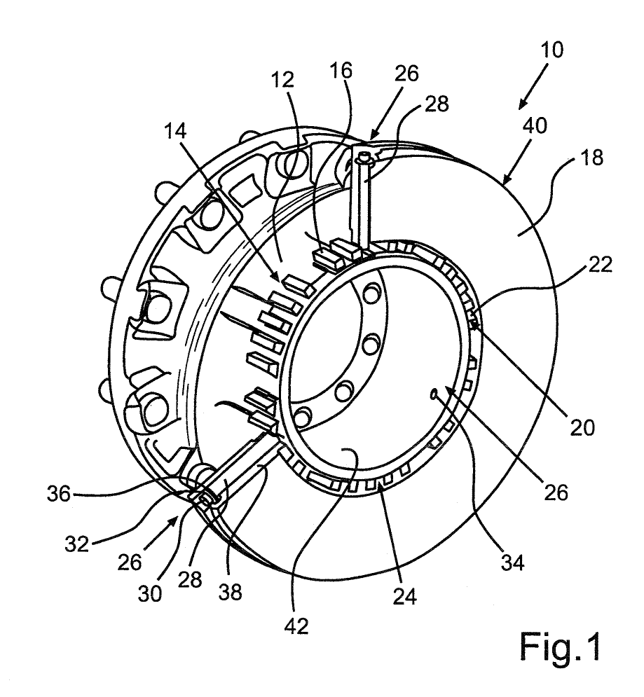

FIG. 1 shows a perspective of a two-part disk brake of a heavy goods vehicle with a wheel hub, and a friction ring partially in section, which are firmly interconnected radially by a form lock and axially by three securing elements, wherein the three securing elements of a receiving recess respectively assigned proceeding radially within the friction ring, wherein the friction ring is radially movable relative to the securing element in the area of the respective receiving recess, and wherein the respective securing elements are formed by sleeves, which are fixed to the wheel hub by means of screws.

In FIG. 1 can be seen a wheel hub 10 in a schematic perspective of a disk brake of a vehicle, presently especially a heavy goods vehicle, which is provided with a corresponding gearing 14 with a plurality of teeth 16 in a flange region 12 proceeding in the axial direction of the wheel hub 10.

A friction ring 18 is attached to the flange region 12 of the wheel hub 10, which ring is provided with an inner gearing 22 at its inner circumferential side 20 corresponding to the outer gearing 14 to the wheel hub side. A form lock or a form-locking shaft—hub—connection in the radial direction is thus created by the outer gearing 14 of the wheel hub 10 or the inner gearing 22 of the friction ring 18. In other words, the friction ring 18 and a present form lock 24 is hereby fixed in the axial direction or in the circumferential direction at the wheel hub 10. The form lock 24 is thereby presently especially designed as a spline shaft or as an evolvent connection.

It can further be seen from FIG. 1, that the friction ring 18 axially displaceable by the form lock 24 with regard to the wheel hub 10 is held axially secured at the wheel hub 10, as a plurality of axial securing elements 26 are provided. In the present embodiment, three of these securing elements 26 are provided, wherein the friction ring 18 is cut out in such a manner that the cuts proceed in the arrangement area of two securing elements 26.

Each securing element 26 comprises a tube-like sleeve with a corresponding central opening, not visible, wherein an assigned screw 30 proceeds. The screw 30 is thereby screwed into an associated threaded bore 34 into the flange region 12 of the wheel hub 10 with its one respective screw head 32 turned away, whereby the sleeve 28 is fixed correspondingly. The screw 30 thereby comprises a disk collar 36 arranged below the screw head 32, which is supported on the sleeve 28.

The respective securing element 26—that is, the respective screw 30 and the respective sleeve 28—are arranged within a corresponding receiving recess 38, which radially penetrates the friction ring 18 from an outer circumferential side 40 to the inner circumferential side 20 or the wheel hub 10 and is thus formed as a passage opening. The respective screw 30 is thereby screwed in from the outer circumferential side 40. A depression is thereby introduced into the receiving recess 38 in the area of the respective screw head 32. However, it has to be noted here that the screw head 32 or the disk collar 36 are formed at the most with the same size as the cross section of the sleeve 28. Especially, the screw head 32 and the disk collar 36, is even formed at least slightly smaller than the cross section of the sleeve 28 which surrounds the screw shaft on the outer circumferential side. From FIG. 1, it can further be seen that the three securing elements 26 are arranged distributed with a same mutual angle of presently about 120 degrees, namely in such a manner that the securing elements 26—or the respective sleeves 28 and the respective screws 30—extend radially or radiantly to the axis of the wheel hub 10 or the friction ring 18. It is to be included within the scope of the invention that another number of securing elements 26 could naturally be provided to secure the friction ring 18 axially to the wheel hub 10.

As the screw heads 32 or the disk collars 36 are, seen in their cross section, at least not formed larger than the cross section of the respective sleeve 28, it is achieved thereby that the friction ring 18 can be moved radially in the area of the respective receiving recess 38 relative to the corresponding securing element 26. This radial mobility is especially necessary to be able to adjust thermal expansions or uneven temperature distributions of the friction ring 18. As the friction ring 18 is not fixed by the securing elements 26 in the radial direction, its contour can vary especially in the region of the outer circumferential side 40 corresponding to the respective temperature distribution.

In other words, the friction ring 18 can be moved freely in the region of the respective receiving recess 38 or held in a floating manner by means of the securing elements 26. An entry of tensions via the securing elements 26 is prevented thereby. It shall be noted here that the sleeves 38 are adapted with their cross section to that one of the receiving recesses 38. The desired axial fixing of the friction ring 18 by means of the securing elements 26 is achieved hereby on the one hand, and the guided free extension of the friction ring 18 is ensured and on the other hand.

It shall be included within the scope of the invention that the sleeves 28 could also be screwed at an inner circumferential side 42 of the flange region 12. In the predominant cases, a considerably simple assembly is however possible by the screwing of the screws 30 from the outer circumferential side 40 of the friction ring 18.

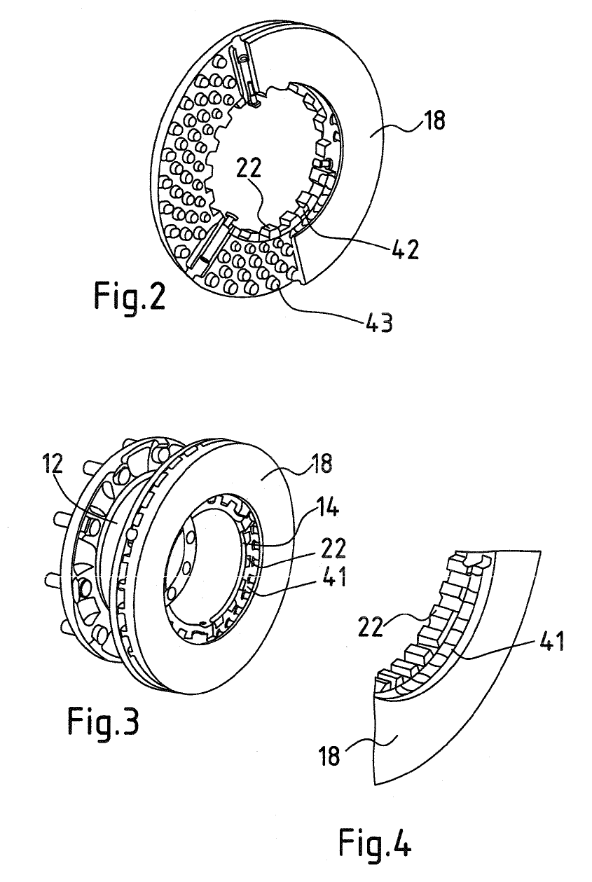

The friction ring is provided with venting channels in a further advantageous design. The channels can thereby for example be formed by continuous webs or also by a plurality of connecting pins between the two sides of the friction ring. These designs are shown in FIGS. 2, 3 and 4 in an exemplary manner. The venting channels proceed within the friction ring and are opened at least to the outside, that is, to the outer circumference of the friction ring, so as to let air pass in or out. The venting channels are particularly preferably, at least partially, opened towards the inside, that is, in the direction towards the flange region. In FIG. 2, the venting channels are formed by a plurality of connecting pins (43). It is ensured hereby that the friction ring can be completely flown through by cooling air in the radial direction. The venting openings (41) or the opened venting channels (42) thereby preferably do not extend over the total thickness of the friction ring. The brake disk is rather preferably divided into a region of the gearing without venting openings or channels and a region with ventings, but without gearing. For this, the venting openings (41) or opened venting channels (42) are only arranged outside the gearing region of the outer gearing (14) and inner gearing (12).

FIG. 2 shows an embodiment in which the thickness of the gearing and of the venting region is about half the thickness of the brake disk. The thickness of the venting region, over which extend the venting openings or open channels, is preferably at 20 to 70% of the friction disk ring.

FIG. 3 shows a brake disk with a friction ring after the attachment to the flange region of the wheel hub (10) or the brake disk pot. The area of the venting channels (41) opened towards the inside thereby projects laterally; outside the flange region, the channels are thereby opened towards the inside. The channels have approximately twice the thickness in the outer circumference of the friction ring as on the respective opposite inwardly directed openings in the form of opened venting channels (41).

For the assembly of the disk brake, the friction ring 18 is thus first attached to the flange region 12, whereby the outer gearing 14 of the flange region 12 engages the inner gearing 22 of the friction ring 18, whereby the form lock 24 forms. The friction ring 18 is thus fixed in the radial direction or the circumferential direction at the wheel hub 10. The axial fixing of the friction ring 18 at the wheel hub 10 takes place subsequently in that corresponding sleeves 28 are inserted into the corresponding receiving recesses 38 of the friction ring 18, whereafter the respective screws 30 can be screwed into the corresponding threaded bores 34 of the flange region 12 of the wheel hub 10.

1. A disk brake, especially for a motor vehicle, with a brake disk and a wheel hub (10) and a friction ring (18), which are firmly interconnected radially by a form lock (24), and axially by at least one securing element (26), wherein the at least one axial securing element (26) is arranged in a receiving recess (38) which extends radially inside the friction ring (18), wherein the friction ring (18) is radially movable relative to the securing element (26) in the area of the receiving recess (38).

2. The disk brake according to claim 1, wherein the friction ring has venting openings (41) or opened venting channels (42) towards the flange region (12).

3. The disk brake according to claim 2, wherein the venting openings (41) or opened venting channels (42) are only arranged outside the gearing region of outer gearing (14) and inner gearing (22).

4. The disk brake according to claim 2, wherein the venting openings (41) or opened venting channels (42) extend over 20 to 70% of the thickness of the friction ring, wherein the remaining thickness region is provided with the inner gearing (22).

5. The disk brake according to claim 1, wherein the securing element (26) comprises a sleeve (28) fastened to the wheel hub (10) by means of a screw (30), which sleeve surrounds the screw (30) on the outer circumference.

6. The disk brake according to claim 2, wherein the receiving recess (38) is formed as a passage opening, which penetrates the friction ring (18) radially from an outer circumferential side (40) to the wheel hub (10).

7. The disk brake according to claim 2, wherein the screw (30) is screwed in from the outer circumferential side (40) of the friction ring (18), wherein one screw head (32) is dimensioned smaller in its diameter than the receiving recess (38).

8. The disk brake according to claim 2, wherein the sleeve (28) is adapted to the receiving recess (38) of the friction ring (18) in its cross section.

9. The disk brake according to claim 2, wherein a plurality of securing elements (26) is provided, which are preferably arranged with the same mutual angles.

10. A method for the assembly of a disk brake, especially for a motor vehicle, comprising:
firmly interconnecting a wheel hub (10) and a friction ring (18), radially by a form lock (24) and axially by at least one securing element (26), wherein the at least one axial securing element (26) is arranged in a receiving recess (38) which extends radially inside the friction ring (18) and is fastened to the wheel hub (10).
